(19) United States
(12) Patent Application Publication
(10) Pub. No.: US 2005/0057849 A1
(43) Pub. Date: Mar. 17, 2005

(54) Encapsulated data storage system

(76) Inventors: Randolph Twogood, Parker, CO (US); Gary Downing, Centennial, CO (US); Bryan Smith, Parker, CO (US); Hyeong Park, Aurora, CO (US)

Correspondence Address: MILES & STOCKBRIDGE PC, 1751 PINNACLE DRIVE, SUITE 500, MCLEAN, VA, 22102-3833, US

(21) Appl. No.: 10/660,757

(22) Filed: Sep. 12, 2003

(51) Int. Cl. G11B 33/14

(52) U.S. Cl. 360/97.02; 360/60; 313/15

(57) ABSTRACT

Disclosed is a naturally encapsulated disposable data storage system for storing and retrieving data from within a self-contained environment and a method for encapsulation of data storage devices. The encapsulated data storage system contains one or more data storage devices that are encapsulated in a manner impervious to external environments. The natural encapsulation method enables the creation of a self-contained environment for the operation of the data storage devices, while maintaining a hermetic seal between the data storage devices and the surrounding environment and allowing the encapsulation to occur at ambient temperature and pressure.

In certain applications it is desirable to record data using a system impervious to the surrounding environment, especially a harsh environment.

The phrase “harsh environment” is used here to mean any environment where extremes of temperature, pressure, humidity, vibration, acceleration, or corrosive elements exist that would normally preclude the operation of electrical devices not designed and constructed to withstand such environments.

In one exemplary embodiment of the present invention, data from scientific test instruments is recorded with an encapsulated data storage system. The scientific test is being performed in a harsh environment. The test instruments provide data signals to a central computer. The central computer, in turn, stores the data signals on the encapsulated data storage system. Upon completion of the test, the encapsulated data storage system may be removed from the harsh environment and the data may be retrieved for subsequent analysis or other manipulation.

In a preferred embodiment of the present invention, the data storage system is a disk drive and is encapsulated naturally. The term “naturally encapsulated” is used here to indicate that the data storage system is sealed with a volume of ambient air inside the encapsulant. The ambient air may have the pressure, temperature, and/or content pre-existing in the general area where encapsulation is performed, without any special preparation or treatment.

### BRIEF DESCRIPTION OF DRAWINGS

FIG. 1 is a high-level block diagram of a naturally encapsulated data storage system constructed in accordance with one exemplary embodiment of the present invention;

FIG. 2 is a flow chart of a method of encapsulating the interior enclosure within the exterior enclosure;

FIG. 3 is a flow chart expanding upon the step of installing the data storage devices into the interior enclosure;

FIG. 4 is a flow chart of a method of collecting data in a harsh environment using the naturally encapsulated data storage system;

FIG. 5 is a flow chart of a method of reading data in a harsh environment using the naturally encapsulated data storage system;

FIG. 6 is an exploded view of the exterior enclosure with interior enclosure installed;

FIG. 7 is a photograph of an interior enclosure suspended in an exterior enclosure prior to pouring encapsulant;

FIG. 8 is a photograph showing the data storage devices within the interior enclosure, which are used by the system of FIG. 1;

FIG. 9 is a photograph showing in greater detail the application of the epoxy material to the sides and top of the interior enclosure, this application is a step in the method described by FIG. 4;

FIG. 10 is a photograph showing a fully encapsulated interior enclosure contained within an exterior enclosure, which is used by the system of FIG. 1;

FIGS. 11(a)-11(f) describe a time lapse sequence of inserting the interior enclosure within the exterior enclosure and pouring encapsulant;

FIG. 12 describes the connection of the data storage devices to the interface connector in detail;

FIG. 13 describes an encapsulated interior enclosure with an interface connector penetrating the encapsulant;

FIG. 14 describes an encapsulated interior enclosure that communicates wirelessly with no interface connectors penetrating the encapsulant; and

FIG. 15 describes a system using the naturally encapsulated data storage system.

### DETAILED DESCRIPTION

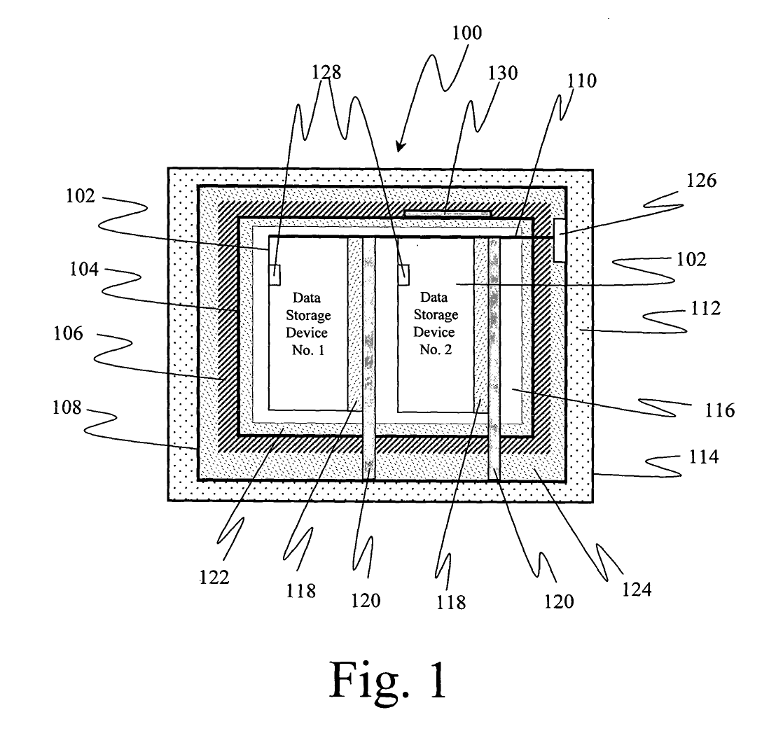

Referring to FIG. 1, an exemplary embodiment of a naturally encapsulated data storage system 100 is described from a high-level block diagram perspective. The naturally encapsulated data storage system 100 generally comprises:
one or more data storage devices 102 (two are illustrated);
an interior enclosure 104 containing the data storage devices 102 and a volume of air;
an encapsulant 106 surrounding and sealing the interior enclosure 104;
an exterior enclosure 108 that contains the encapsulant 106 and the interior enclosure 104;
a back plane 110, which controls the heating elements, contains battle override circuitry, and connects the data storage devices 102;
a means for damping vibration 112 that attaches the exterior enclosure 108 to the housing 114;
a housing 114 which contains the exterior enclosure 108;
a finite volume of air 116 sufficient for operation of the data storage devices 102;
thermal transfer pads 118 attached to the data storage devices 102;
thermal transfer plates 120 for dissipating heat attached to the data storage devices 102;
a thermal transfer pad 122 lining the interior enclosure 104;
a thermal transfer pad 124 lining the exterior enclosure 108;
an interface connector 126 for communicating data and providing power to the data storage devices 102;
temperature sensors 128 for sensing the temperature of the data storage devices 102, and
heating elements 130 for providing heat to the interior enclosure.

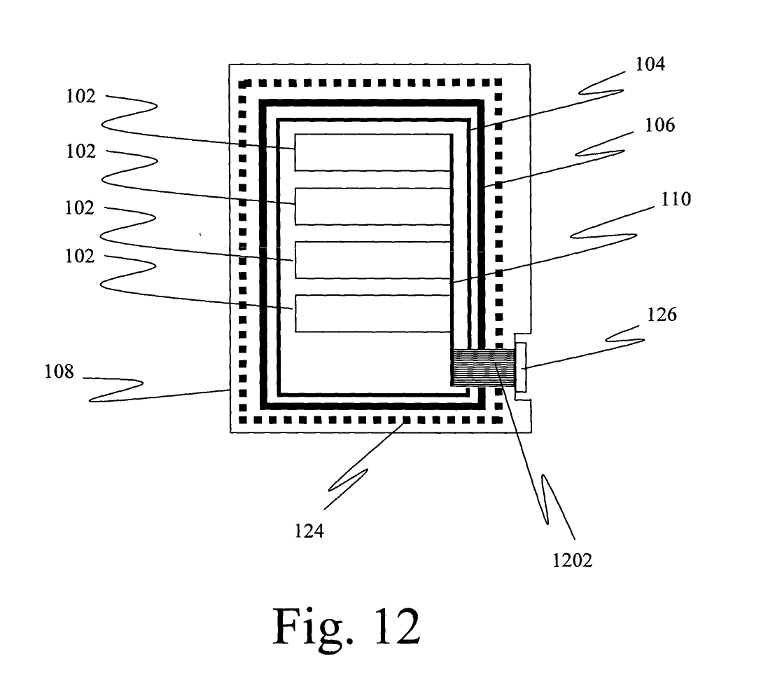

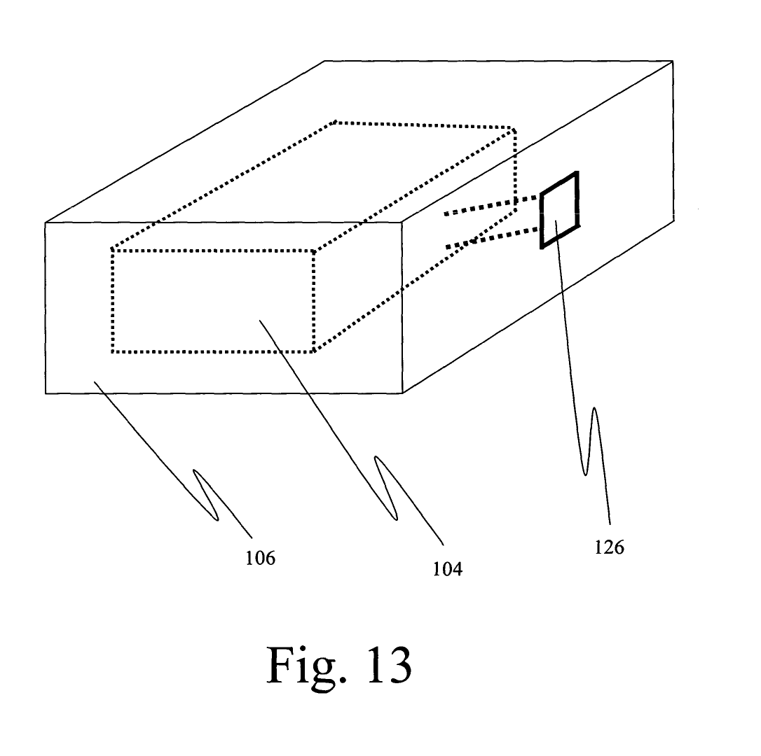

The naturally encapsulated data storage system 100 is designed to allow the storage and retrieval of data from within a self-contained environment. Data is stored and retrieved through interface connector 126, which may be a connector or a cable. In FIG. 12, the means of connecting the data storage devices 102 to the external interface connector 126 is shown in greater detail. A flex cable 1202 may be connected to the back plane 110 and carry the data and power signals through the interior enclosure 104, the encapsulant 106, and on to the interface connector 126 which may be recessed into the exterior enclosure 108.

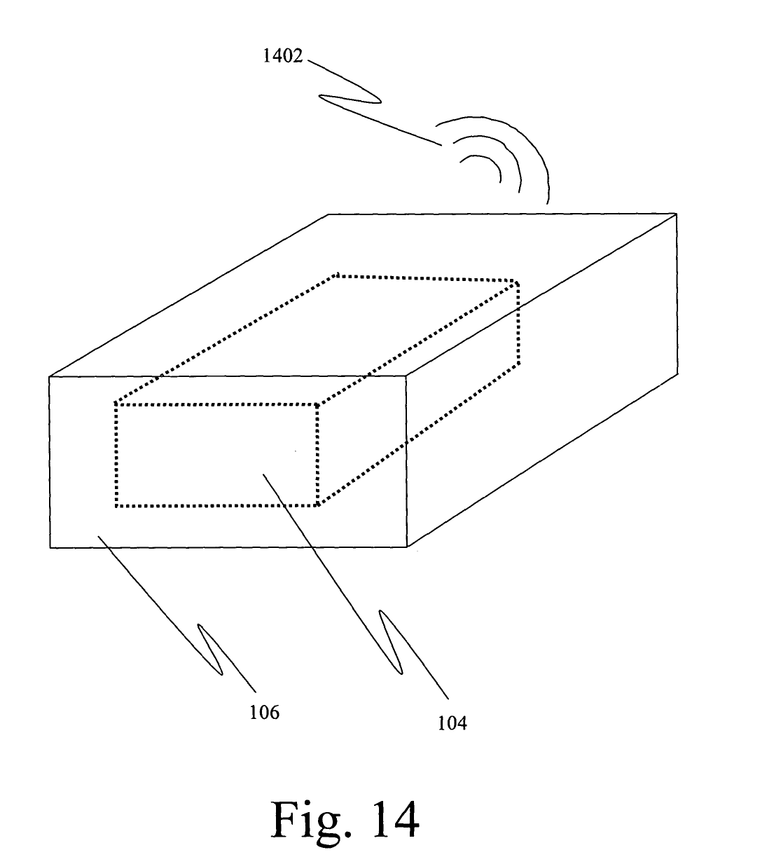

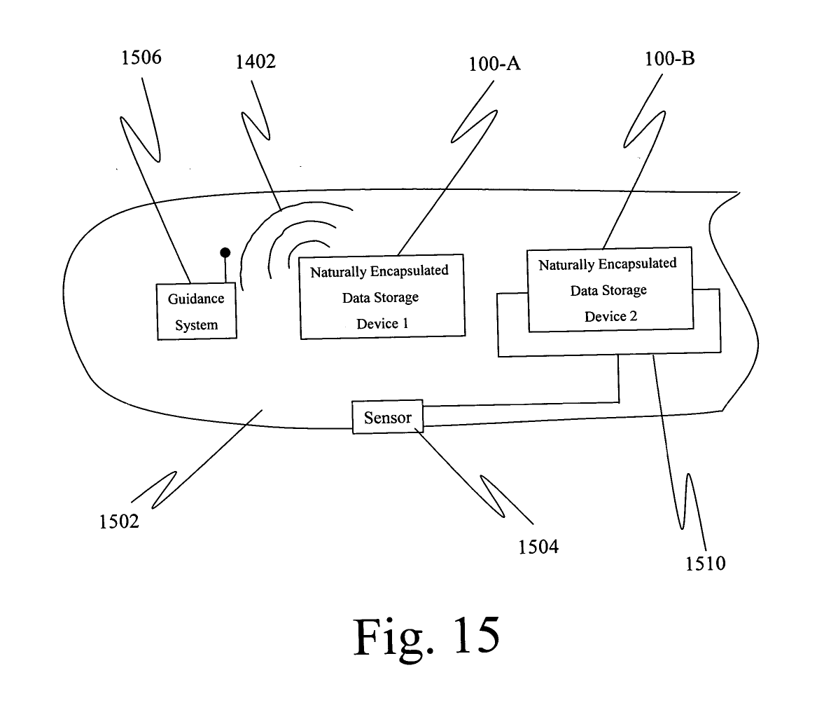

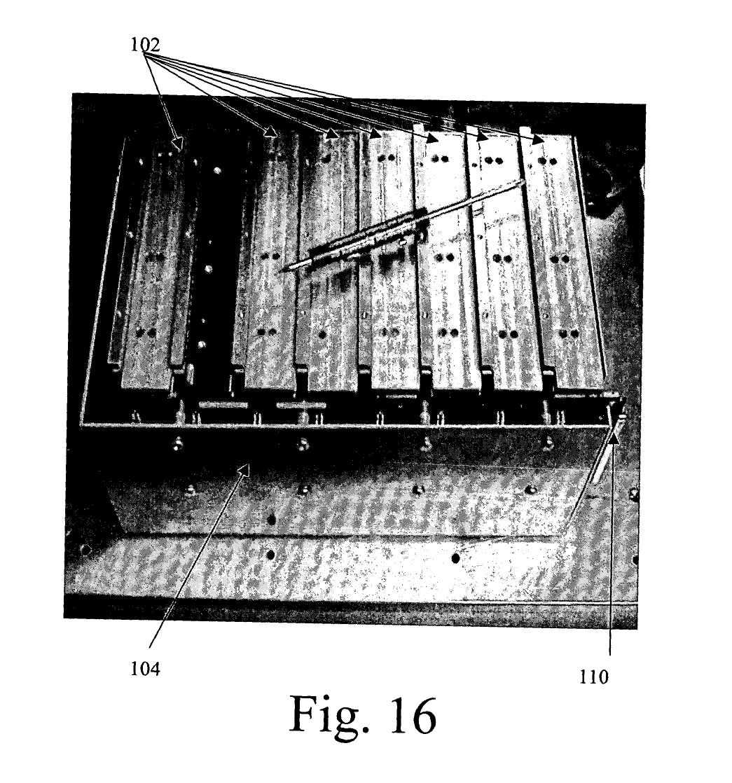

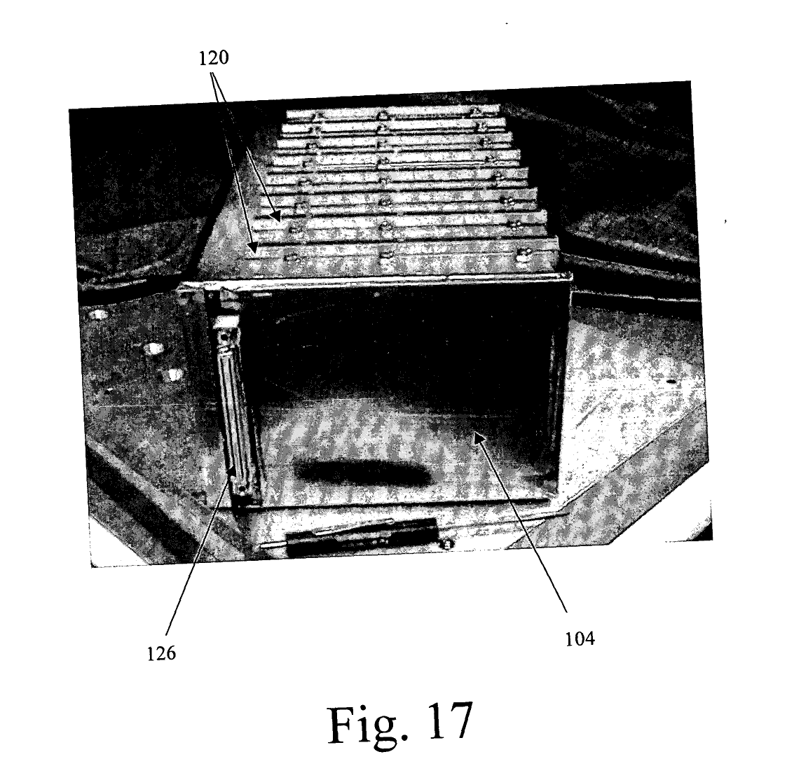

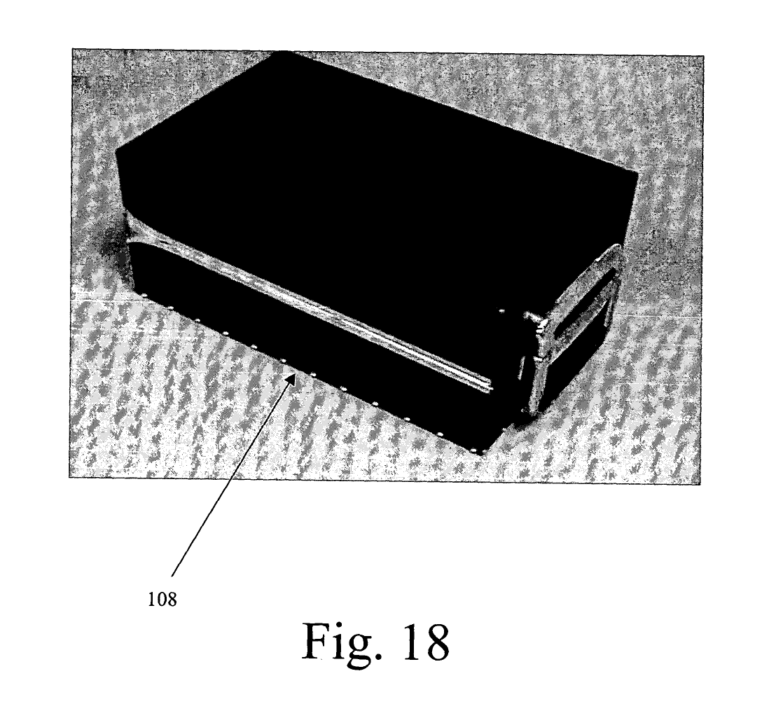

Alternately, as shown in FIG. 14 and FIG. 15 data may be input and/or output by a wireless connection 1402 communicating wirelessly through encapsulant 106 without the need for encapsulant 106 shell to be penetrated by a cable or connector for communicating data and delivering power.

The naturally encapsulated data storage system 100 contains an array of one or more data storage devices 102. In an exemplary embodiment, the data storage devices 102 may be commercial off-the-shelf (COTS) hard disk drive units. The number and capacity of data storage devices 102 can be varied according to contemplated uses. As an exemplary embodiment, the naturally encapsulated data storage system 100 may provide space for a number of data storage devices 102 ranging between one and eight. This allows for a data storage system that can be scaled to the requirements of a particular application. The COTS hard disk drive units may have capacities ranging from hundreds of megabytes in a low-end application, to hundreds of gigabytes, and even terabytes, for higher end applications. As an example, presently available COTS hard disk drive units allow for capacity of up to 1.6 terabytes of storage in a single naturally encapsulated data storage system 100. As storage densities of hard disk drive units change in the future, an even greater capacity for storage may be provided. By using COTS hard disk drive units, the naturally encapsulated data storage system 100 may achieve a very low cost per gigabyte of storage.

In another exemplary embodiment, the data storage device 102 may be a counter-balance mounted hard disk drive, which may offset gyroscopic upsets during power on and power off in a zero gravity or near zero gravity environment.

In another exemplary embodiment, the data storage device 102 may be constructed with a lead-based lining for resistance to the effects of an environment where radiation may be present.

In a preferred embodiment, a hard disk drive controller assembly controls the data storage devices 102. The data storage devices 102 may be of uniform size in order to facilitate the operation of the hard disk drive controller. The hard disk drive controllers may come in multiple computer interface formats including PCI and CPCI. The hard disk drive controllers may have an industry standard interface, Front Panel Data Port (FPDP). In addition the hard disk drive controllers may be supplied with software that may allow for the operation of the controller and for development of more sophisticated control software.

A computer may control the encapsulated data storage system. In an exemplary embodiment, the control computer may be a PCI based motherboard, with dual Intel Corp. Xeon processors operating at 2.8 GHz, 0.5 gigabytes of random access memory (RAM), and two StreamStor™ hard disk drive controller cards, (from Conduant Corporation, Longmont, Colo.), each operating two 200 gigabyte data storage devices 102 and supporting 512 megabytes of on-board RAM for buffering. Using this exemplary embodiment, laboratory tests have been conducted on the sustained throughput capacity of the system with the following results: 187 megabytes/second data write rate, and approximately 157 megabytes/second data read rate. While these rates of transfer were achieved with the exemplary system described, it is anticipated that a most preferred embodiment of the naturally encapsulated data storage system 100 may be able to achieve data transfer rates of 200 megabytes/second or greater.

The naturally encapsulated data storage system 100 may be used in military environments and may be required to meet the following environmental parameters: Operation temperature −20° C. to +55 C (intermittently to +71° C.); Storage temperature −55° C. to +85° C.; Shock 40G ½ sine 11 ms (conforming to military specification MIL-STD-810C) Non-operational; altitude>70K feet above sea level; and humidity 100% (condensing).

The encapsulated data storage system 100 is designed to be disposable, removable, and portable.

The self-contained environment is created by naturally encapsulating the interior enclosure 104, which houses the data storage devices 102 and a finite volume of air 116 sufficient for the data storage devices 102 to operate. During the encapsulation process the encapsulant 106 is used to completely encapsulate the interior enclosure 104 and the volume of air 116 that may be present between the data storage devices 102 and the interior enclosure 104. In doing so, a volume of air 116 sufficient to operate the data storage devices 102 is retained and prevented from escaping the interior enclosure 104, while outside air is prevented from penetrating the interior enclosure 104. The drawing of FIG. 1 is not to scale and the area taken up by the volume of air 116 has been exaggerated for illustration purposes.

The encapsulant 106, when cured, forms a rigid, one piece shell that completely surrounds and hermetically seals the data storage devices 102 without the need for mechanical closures.

In an exemplary embodiment, the housing 112 may be an “off-the-shelf” enclosure capable of meeting the criteria set forth for operation in a military environment. The exemplary enclosure may be a sealed type or an air breathing (ATR) type. In another possible embodiment of the housing 112, a shock and vibration isolation tray may be used to further isolate the naturally encapsulated data storage system 100 from the vibration and shock that may be present. Additionally the housing 112 may be selected to be thermally conductive and thereby increasing the thermal conduction ability of the naturally encapsulated data storage system 100 by allowing heat to be dissipated through housing 112.

In a preferred exemplary embodiment, the housing 112 may be an isolation tray system that may provide heat-sinking capability as well as vibration damping characteristics. The tray may be constructed of 0.50-inch aluminum plate that interfaces with the exterior enclosure lid surface. In an exemplary embodiment, the isolation tray plate may be grooved such that fins may be created with 0.20 inches of depth, 0.20 inches thick, and are spaced at 0.40 inches apart. These grooves may increase the surface area and aid airflow required for convection cooling while remaining stiff enough to hold the disk system in place. The grooved surface may allow for four pads that are used to mount the elastomeric vibration isolators to the isolation tray plate. These elastomeric vibration isolators are a preferred embodiment of a means for damping vibration 112 that attaches the exterior enclosure 108 to the housing 114. In a most preferred embodiment the elastomeric vibration isolators may be purchased from BarryMount Systems, Inc. and tuned to the weight of the disk system. The exemplary isolators offer 3 axes damping with maximum displacement of 0.32 inches and natural resonance of less than 16 Hz. Because of the high displacement value, the mating connector and guide mechanism may be part of the isolation tray. The rear panel may house the mating hardware and guide assembly for plug and play compatibility, where plug and play compatibility means the ability to insert and remove the naturally encapsulated data storage system 100 easily and with the electronic interface readily accepting new naturally encapsulated data storage systems 100 being connected. The subsequent cable assembly may provide sufficient sway space to accommodate maximum displacement of the isolators. In addition, it may be desirable that the connector and guide mechanisms are interchangeable with the configuration of the naturally encapsulated data storage system 100. The isolators must be tuned to a specific weight and, as such, will change from one disk configuration to another.

To demonstrate a possible use, consider the case of recording data aboard an aircraft; examples of aircraft include airplanes, helicopters, rockets, missiles, airships, balloons, and unmanned aerial vehicles. At high altitudes there may be air density and temperature extremes that might prevent traditional data storage devices from functioning properly. By utilizing an encapsulated data storage system 100, data may be collected and stored in a high altitude environment. Due to the self-contained environment of the encapsulated data storage system 100, data storage devices 102 within the encapsulated data storage system 100 are unaffected by the high altitude environment possibly presented aboard aircraft.

To demonstrate another possible use, consider the case of data collection in a marine environment aboard a vessel such as a ship, submarine, or torpedo. In a marine environment water may be present along with potentially corrosive elements; there may be a lack of air and possibly high atmospheric pressure. Here, the encapsulated data storage system 100 allows storage and retrieval of data without regard to the harsh environment presented in marine applications.

Another possible use is in underground environments, where high air density may be present and potentially corrosive elements may also be present. Examples of underground applications include mining, geological exploration, and petroleum exploration. Here, the encapsulated data storage system 100 allows storage and retrieval of data without regard to the harsh environment presented in underground applications.

Still another possible use is in an environment where dust, sand, mold, fungus, or any other corrosive agent may be present.

In all of the above-mentioned possible uses, the naturally encapsulated data storage system 100 may be disposable. This is facilitated by the low cost of encapsulating the data storage device naturally, as opposed to the possible high cost of other hermetic sealing methods. A disposable system may permit the use or collection of data in environments that were previously considered too harsh to risk non-disposable equipment and in doing so promote scientific research.

Similarly, the naturally encapsulated data storage system 100 is preferably portable and removable from external structures after use, this may permit the storage device to be transported to the harsh environment for data storage and transported away from the harsh environment for data retrieval, separate from external structures to with which it may cooperate. The interface connector 126 may allow for the encapsulated data storage system 100 to be easily inserted into an external structure for purposes of data collection and retrieval.

In an exemplary embodiment, there may be a docking station for the encapsulated data storage system 100 that may allow for easy insertion and removal of the encapsulated data storage system 100. The docking station could be located in the data collection environment and/or in the data retrieval environment. The docking station facilitates rapid removal and replacement of the encapsulated data storage system 100.

In an exemplary embodiment a protocol is used for data storage and retrieval through interface connector 126, such as ATA, SATA, IDE, EIDE, SCSI. SCSI-II, SCSI-III, or other protocol used for data and control communication with mass data storage devices 102.

The encapsulated data storage system 100 allows for data storage to occur in environments where matter that may be harmful to persons is present. Upon completion of data storage in a harmful environment, the encapsulated data storage system 100 can be washed or scrubbed to remove the harmful matter, while still maintaining the self-contained environment and preserving the data storage devices 102. Once washed or scrubbed properly the encapsulated data storage system 100 allows for the safe retrieval of data by persons. Examples of harmful environments include environments where nuclear, biological, or chemical agents are present that would be harmful to people.

A need may exist for the data storage devices 102 to dissipate heat during operation, particularly special considerations may be needed for the printed circuit board (PCB) that may be found in the data storage devices 102. The encapsulated data storage system 100 accomplishes heat dissipation from the data storage devices 102 by means of thermal conduction. A thermal transfer pad 118 may be attached to data storage device 102 covering the printed circuit board (PCB) of the data storage device 102. A thermal transfer plate 120 may then be attached to the data storage device 102 over top of the thermal transfer pad 118 making mechanical contact. A portion of the thermal transfer plate 120 protrudes from the encapsulant 106 after the encapsulation process. This protrusion of the thermal transfer plate 120 provides a means for thermal conduction of heat from the data storage device 102 to the surrounding environment.

Further, a need may exist for heat to be transferred into the data storage devices 102 to achieve operational temperatures in a cold environment that may prevent the normal operation of the data storage devices 102. In the exemplary embodiment, two electric heating elements 130 are attached to the outside surface of the interior enclosure 104. In a preferred embodiment, these heating elements 130 may be 10 W units each.

The temperature of the data storage devices may be monitored through a thermal sensor 128 attached to each data storage device 102. In a preferred embodiment, the thermal sensor 128 may be a thermocouple or a thermistor. If the temperature of the data storage devices at the PCB 102 as measured by the thermal sensor 128 is below operational temperature, the data storage devices are disabled and the power is diverted to the heating elements 130 which activate and provide heat to the interior enclosure 104. The temperature is monitored via the thermal sensor 128 and when operational temperature is reached, the heating elements 130 are deactivated, power is diverted to the data storage devices and normal operation is restored.

In addition, in an exemplary embodiment, the thermal sensor 128 may detect an overheating condition and provide an automatic shutoff for the data storage devices 102 to protect the data storage devices 102 from damage.

In an exemplary embodiment the circuitry for thermal regulation of the data storage devices may reside on the back plane 110. The back plane 110 may also contain a battle override switch, which allows the data storage devices 102 to continue to attempt operation in an environment that is either too cold or too hot for normal operation. The battle override switch feature may be necessary in a battlefield environment where continued operation may be desired over protection of equipment.

A laboratory test was conducted using an exemplary embodiment of a data storage device. A purpose of this was to thermally characterize an exemplary data storage device in a standalone configuration. The exemplary data storage device used in this test was a commercial off the shelf hard disk drive. The test was conducted at ambient temperature, about 23C and at 100% duty cycle for the data storage device. The data storage device was instrumented with temperature sensors in four locations, the processor on the printed circuit board (PCB), the under side of the drive adjacent to the spindle, the under side of the drive adjacent to the spindle and opposite the previous sensor, and in the ambient air. The test was conducted over a time span of eighteen hours with the following observations:
temperature adjacent the spindle measured between 35° C. and 38° C.; and
temperature on the PCB processor measured between 50° C. and 55° C., with brief spikes to 60° C.

A second laboratory test was conducted to further thermally characterize an exemplary data storage device 102. In this second test, the data storage device 102 was fitted with an exemplary thermal transfer pad and an exemplary thermal transfer plate. The test was conducted at ambient temperature, about 23° C. and with a 100% duty cycle on the data storage device 102. Again in this test, the exemplary data storage device was a commercial off-the-shelf hard disk drive. The data storage device was instrumented with temperature sensors in four locations, the processor on the printed circuit board (PCB), the under side of the drive adjacent to the spindle, the under side of the drive adjacent to the spindle and opposite the previous sensor, and in the ambient air. The test was conducted over a time span of eighteen hours with the following observations:
temperature adjacent the spindle measured between 42° C. and 47° C.; and
temperature on the PCB processor measured between 47° C. and 54° C.

A third laboratory test was conducted in order to further thermally characterize an exemplary data storage device. In this test, there were two exemplary data storage devices, which were commercial off-the-shelf hard disk drives. Each of the data storage devices was fitted with the thermal transfer pad and thermal transfer plate. Additionally, in this third test, the data storage devices were placed inside an exemplary interior enclosure. The test was conducted at ambient temperature, about 23° C., and with a 100% duty cycle on the data storage devices 102. There were three temperature measurement sensor used in this test, one on the printed circuit board processor of each of the two data storage devices and one in the ambient air. The test was conducted over a time span of eighteen hours with the following observations:
temperature on the two PCB processors measured between 40° C. and 45° C., with an average temperature of 42° C.

The data storage device 102 may be a fixed disk drive, an optical drive, or similar electromechanical, electromagnetic, electro-optical, or electronic device.

As an exemplary embodiment, fixed disk drives may be used as a data storage device 102. These disk drives may be commercially available models that may be hermetically sealed, may be ruggedly built and may contain various amounts of data storage capacity. A ruggedly built disk drive is one that has been designed and built to better tolerate harsh environments. In the exemplary embodiment the fixed disk drives may require air to operate, but may not consume air during operation, thereby only requiring a finite amount of air for operation.

Thermal transfer pad 118 may be used to conduct heat from the data storage device 102 to the thermal transfer plate 120. In a preferred embodiment, thermal transfer pad 118 may be a soft, thermally conductive gap filling material that is capable of conforming to the space between the data storage device 102 and the thermal transfer plate 120. The thermal transfer pad may be used to direct heat away from the data storage device 102 and into the thermal transfer plate. In a most preferred embodiment the thermal transfer pad may be made of a material manufactured under the Chomerics trade name by Parker Seals called “Therm-A-Gap 570”; or a material with similar desirable properties. In the most preferred embodioment the thermal transfer pad 118 has the following desirable properties:
soft and conformable; and
thermally conductive (1.5 C.°-in²/W @ 0.040 inch thick).
   Additionally, in a preferred embodiment the thermal transfer pad 118 may be comprised of an ultra soft silicone elastomer filled with ceramic particles and may have a fiberglass carrier or an aluminum foil carrier. In the exemplary embodiment the thermal transfer pad 118 may be 0.100 inches thick prior to installation and 0.050 inches thick after installation and compression between data storage device 102 and thermal transfer plate 120.

Thermal transfer plate 120 may be used to conduct heat from thermal transfer pad 118 to the environment outside of the encapsulated data storage devices 102. In a preferred embodiment the thermal transfer plate 120 is metal, ceramic, or other material that is thermally conductive. In a most preferred embodiment the thermal transfer plate 120 may be made of aluminum and may be 0.125 inches thick or 0.0625 inches thick on the area of the thermal transfer plate 120 that is encapsulated and 0.25 inches thick on the portion of the thermal transfer plate 120 that protrudes from the encapsulant 106.

The interior enclosure 104 generally comprises an enclosure of sufficient size to accommodate the data storage devices 102 along with a finite volume of air 116 sufficient for the data storage devices 102 to operate, and a thermal transfer pad 122 attached to the inside of the interior enclosure 104 making mechanical contact with the interior enclosure 104 and with the data storage devices 102. The interior enclosure 104 enables conduction of heat from the data storage devices 102 via the thermal transfer pad 122. The interior enclosure 104 may also serve as a barrier during the encapsulation process to prevent the encapsulant 106 from penetrating the data storage devices 102.

In a most preferred embodiment, interior enclosure 104 may be made of aluminum and may be 0.050 inches thick.

Thermal transfer pad 122 may be a material identical to that used in the thermal transfer pad 118, or one with similar properties.

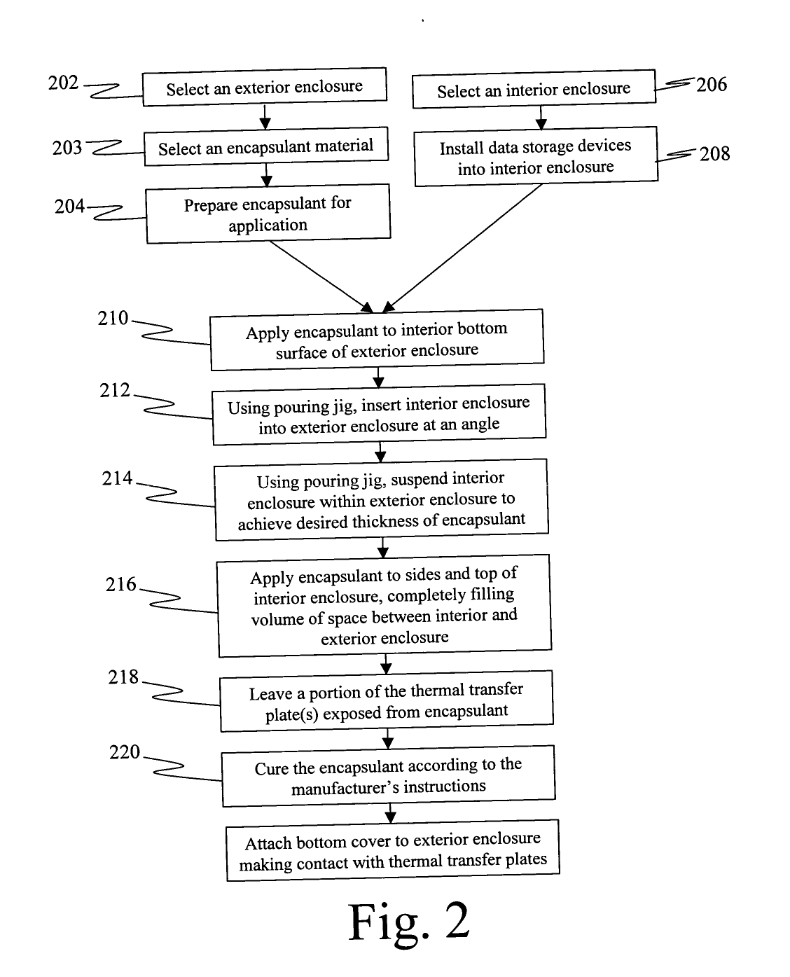

A method of encapsulating interior enclosure 104 is described by the flow chart in FIG. 2. Steps 202 through 204 may be performed in parallel with steps 206 and 208. Referring to FIG. 2, in step 202 (Select an exterior enclosure), a suitable exterior enclosure 108 is selected. This selection may be based on contemplated uses.

In step 203 (Select an encapsulant material), a suitable material is selected for use as encapsulant 106. In a preferred embodiment, the selected material may be a resin epoxy capable of flowing and curing at ambient room tempereatures. In a most preferred embodiment, the selected material is the epoxy-based casting system sold commercially by the Loctite Corporation under the name “Hysol EE4186/HD3561”.

In step 204 (Prepare encapsulant for application), the encapsulant may be mixed in a ration according to the manufacturers instructions. Additionally, the encapsulant may be exposed to a negative air pressure environment (a vacuum) for a time period necessary for air that may be entrapped during the mixing of the encapsulant to escape.

In step 206 (Select an interior enclosure), a suitable interior enclosure 104 is selected. This selection may be based on contemplated uses and preferably comprises selection of 0.050 plate aluminum formed in a box shape for use as interior enclosure 104 with thermal transfer pad 118 lining the inside of the interior enclosure.

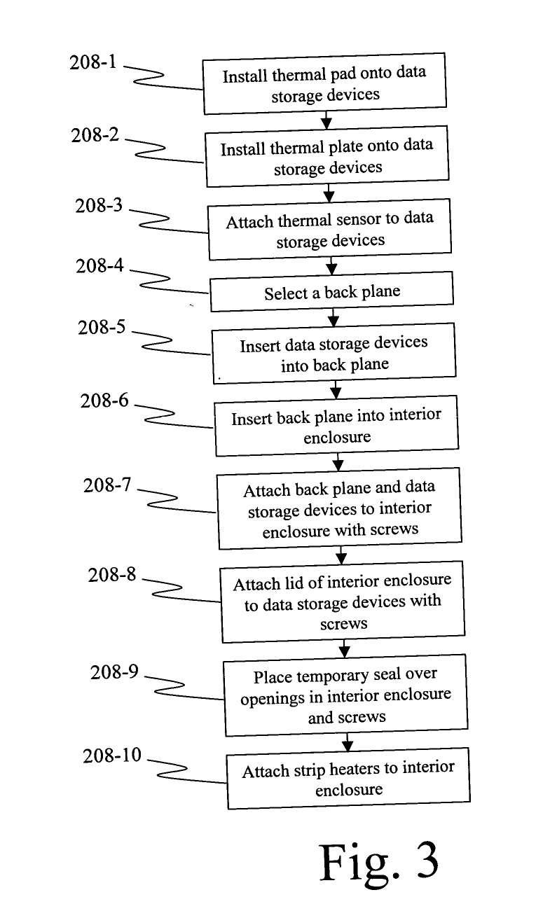

In step 208 (Install data storage devices into interior enclosure), data storage devices consistent with the contemplated uses are installed into the interior enclosure. FIG. 3 elaborates this step in greater detail. Referring to FIG. 3, in sub-step 208-1 (Install thermal pad onto data storage devices), the data storage devices 102 are fitted with a thermal transfer pad 118 covering the printed circuit board region of the data storage device 102.

In sub-step 208-2 (Install thermal plate onto data storage devices), the thermal transfer plate 120 is attached to the data stroage device 102 over top of the thermal transfer pad 118.

In sub-step 208-3 (Attach thermal sensor to data storage devices), thermal sensors 128 are attached to the data storage devices 102.

In sub-step 208-4 (Select a back plane), a back plane 110 is selected that will accommodate the data storage devices 102 and allow for transfer of data and power to and from the data stroage devices 102.

In sub-step 208-5 (Insert data storage devices into back plane), the data storage devices 102 are inserted into the back plane 110 and the connectors for data exchange and power are mated. In addition, the data storage devices 102 are secured to the backplane 110 with screws.

In sub-step 208-6 (Insert back plane into interior enclosure), the back plane 110 with the attached data storage devices 102 is inserted into the interior enclosure 104.

In sub-step 208-7 (Attach back plane and data storage devices to interior enclosure with screws), the back plane 110 and data storage devices 102 are attached to the interior enclosure 104 with printed cicuit board standoffs and screws.

In sub-step 207-8 (Attach lid of interior enclosure to data storage devices with screws), the lid of the interior enclosure 104 is attached to the data storage devices 102 with screws.

In sub-step 208-9 (Place temporary seal over openings in interior enclosure and screws), a compound is placed over any opening in the interior enclosure 104 and over the screws used to mount the back plane 110, data storage devices 102, and lid to the interior enclosure 104. In a preferred embodiment, this compound is a high viscosity epoxy resin. The purpose of using this material to seal the interior enclosure 104 is to provide a temporary seal for the volume of air 116 in the interior enclosure 104 and to prevent the encapsulant 106 from invading the interior enclosure 104 during the encapsulation process. While the sealing in this step is temporary, it is intended to provide a good seal for containing the volume of air 116 inside the interior enclosure 104 for time sufficient to pour the encapsulant 106 and for the encapsulant 106 to cure.

In sub-step 208-10 (Attach strip heaters to interior enclosure), heating elements 130 are attached to the outside of the interior enclosure 104.

Referring back to FIG. 2, in step 210 (Apply encapsulant to interior bottom surface of exterior enclosure), a layer of encapsulant 106 is applied to the inside bottom of the exterior enclosure 108. The exterior enclosure is a box-like member with five closed sides and one open side. The open side is placed up and the encapsulant 106 is poured to the desired thickness on the inside of the exterior enclosure's 108 bottom closed side.

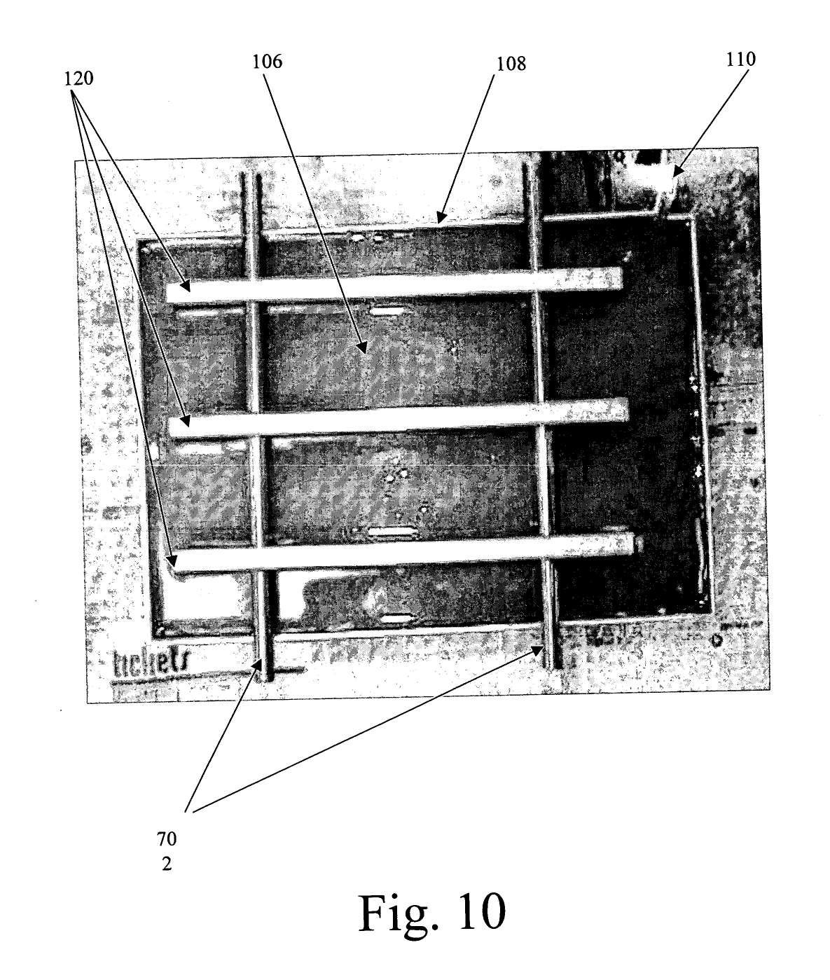

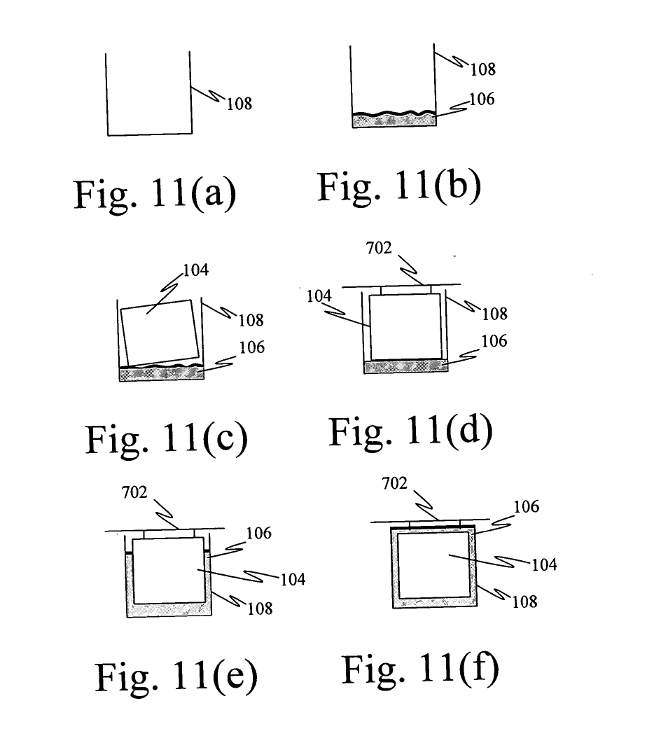

In step 212 (Using pouring jig, insert interior enclosure into exterior enclosure at an angle), a pouring jig 702 is used to position the interior enclosure in such a way as to provide an equal spacing on all sides between the interior enclosure 104 and the exterior enclosure 108. The interior enclosure is then inserted into the exterior enclosure in a particular manner in order to minimize trapped air. The sequence of FIGS. 11(a) through 11(f) provide additional detail.

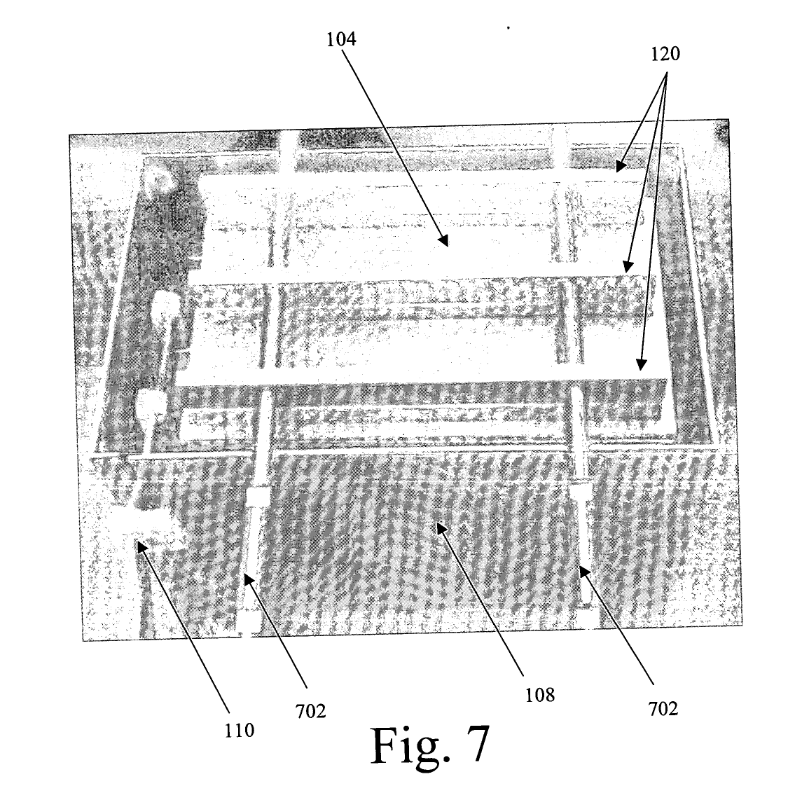

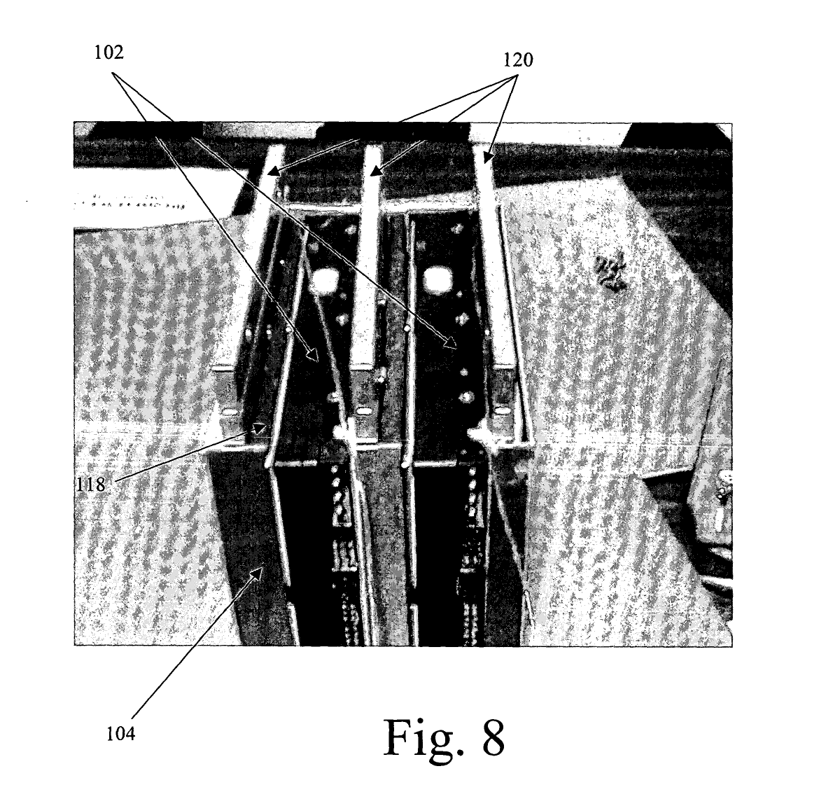

Referring back to FIG. 2, in step 214 (Using pouring jig, suspend interior enclosure within exterior enclosure to achieve desired thickness of encapsulant), the pouring jig may be used to suspend the interior enclosure at the desired spacing to allow for a uniform thickness of encapsulant 106 to be applied. This step is elaborated in further detail in FIG. 7 and FIG. 11(d).

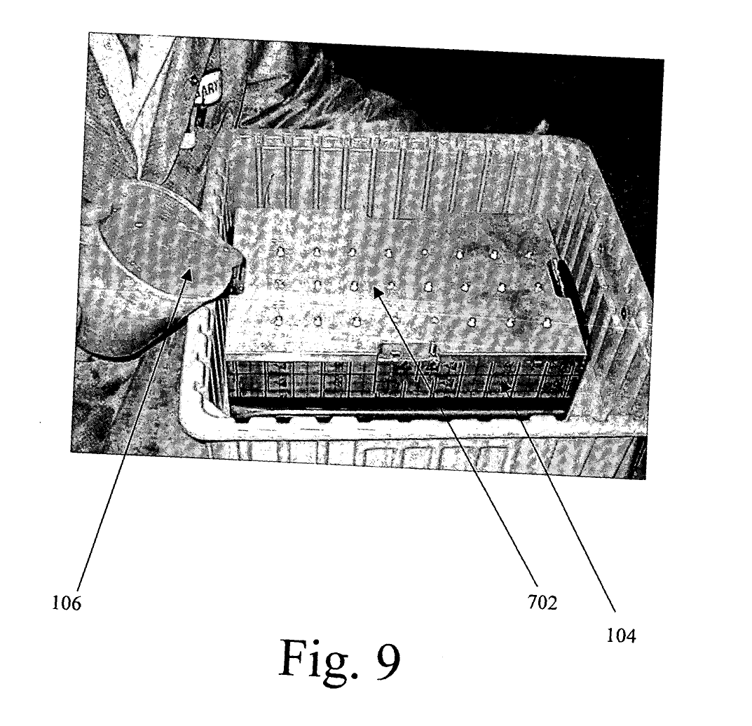

In step 216 (Apply encapsulant to sides and top of interior enclosure, completely filling volume of space between interior and exterior enclosure), the encapsulant 106 is poured between the side of the interior enclosure 104 and the exterior enclosure 108 and over the top of the interior enclosure 104. Step 216 is shown in greater detail in FIG. 9, which contains a photograph of the pouring of encapsulant 106 along the side of the interior enclosure 104 in progress.

In step 218 (Leave a portion of the thermal transfer plate(s) exposed from encapsulant), a portion of the thermal transfer plate 120 is left protruding from the encapsulant 106. This protrusion of the thermal transfer plate 120 from the encapsulant 106 allows for the dissipation of heat from the data storage devices 102 to the outside environment. The exposed portion of the thermal transfer plates is illustrated in FIG. 10.

In step 220 (Cure the encapsulant according to the manufacturer's instructions), the encapsulant 106 is cured according the instructions provided by the manufacture of the encapsulant 106. FIG. 10 provides a view of the cured encapsulant 106 completely covering the interior enclosure.

The FIGS. 11(a) through 11(f) provide a detailed description of the insertion and pouring sequence. Referring to FIG. 11(a), an exterior enclosure 108 is shown in cross section prior to encapsulant 106 or interior enclosure 104 being inserted.

In FIG. 11(b), a layer of encapsulant has been applied to the inside bottom of the exterior enclosure to a desired thickness.

In FIG. 11(c), the interior enclosure 104 is being inserted into the exterior enclosure 108 and contacting the encapsulant 106 at an angle to prevent air from being trapped between the interior enclosure 104 and the encapsulant 106. As the interior enclosure 104 is lowered onto the layer of encapsulant 106, the angle allows for air to escape from beneath the interior enclosure 104.

In FIG. 11(d), the interior enclosure 104 has been inserted into the exterior enclosure 208 and is being suspended by the pouring jig 702.

In FIG. 11(e), encapsulant 106 has been poured between the side of the interior enclosure 104 and exterior enclosure 108.

In FIG. 11(f), the encapsulant 106 has been poured over the top of the interior enclosure 104 and is now completely encapsulating the interior enclosure 104.

In the exemplary embodiment shown, the encapsulant 106 may be a high impact, low viscosity (able to be poured) room temperature cure casting system. In a preferred embodiment this casting system may be epoxy based. In a most preferred embodiment, the slected material may be epoxy-based high impact, low viscosity room temperature cure casting system product sold commercially by the Loctite Corporation as a two part system under the name “Hysol EE4186/HD3561.” In the most preferred embodiment the two parts may be mixed according to manufacturer's recommended ratio of 100 parts of resin “EE4186” to 10 parts of hardener “HD3561”.

The exemplary encapsulant 106 has the following desirable properties:
a. tensile strength of 10,000 psi and flexural strength of 14,000 psi, which makes the encapsulant shell highly resilient, impact resistant, and allows the encapsulant 106 to maintain rigidity and integrity of seal;
b. durable enough to maintain environment for at least about five years;
c. thermal conductivity of 18×10⁻⁴ cal×cm/sec cm²×° C., which allows the encapsulant 106 to both dissipate heat evenly by conducting heat throughout encapsulant shell and, by having a lower conductivity than the thermal transfer plate 120, the encapsulant provides directed dissipation of heat out of the data storage devices through the thermal transfer plate 120;
d. low coefficient of linear thermal expansion (CTE) of 50×10⁻⁶ in/in/° C. for 30° C. to 70° C. and 110×10⁻⁶ in/in/° C. for 70° C. to 90° C., which provides resistance to expansion and shrinkage under varying temperature conditions;
e. resistance to heat and thermal shock;
f. curable at room temperature;
g. good adhesion to aluminum or other metals;
h. non-caustic;
i. low moisture absorption rate of 0.113% during a twenty four hour immersion, which reduces susceptibility to high moisture and corrosive environments;
j. shock absorption, which allows the encapsulant 106 to damp certain frequencies of vibration, including high frequency vibration, and
k. electrically non-conductive, dielectric strength of 1585 volts/mil @ 20 mil thickness, which allows the encapsulant to isolate the data storage devices from the outside environment and allows for the pass through of electrical wires or cables by providing a built-in insulator around the conductor as it passes through the encapsulant 106.

In an exemplary embodiment, encapsulant 106 may be 1/4 inch thick surrounding interior enclosure 104.

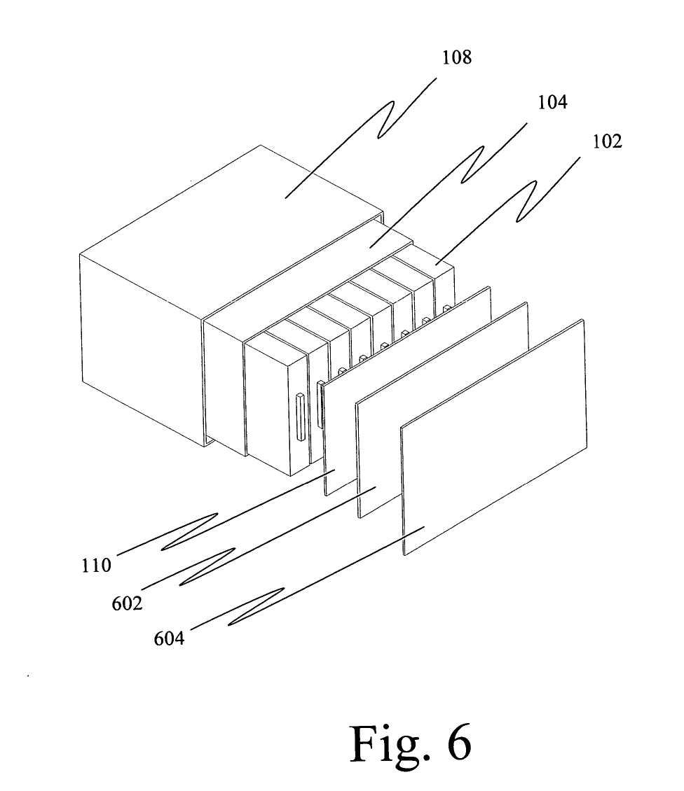

An exemplary embodiment of a fully assembled exterior enclosure 108 is shown in FIG. 6 in exploded view. The cover plate 602 of the interior enclosure 104 is attached prior to encapsulation. Once the encapsulant has cure, the exterior cover plate 604 can be attached to the exterior enclosure 108.

The concept of the interior enclosure 104 within the exterior enclosure 108 creates a double shield environment that may be suited for mitigating electromagnetic interference (EMI) effects.

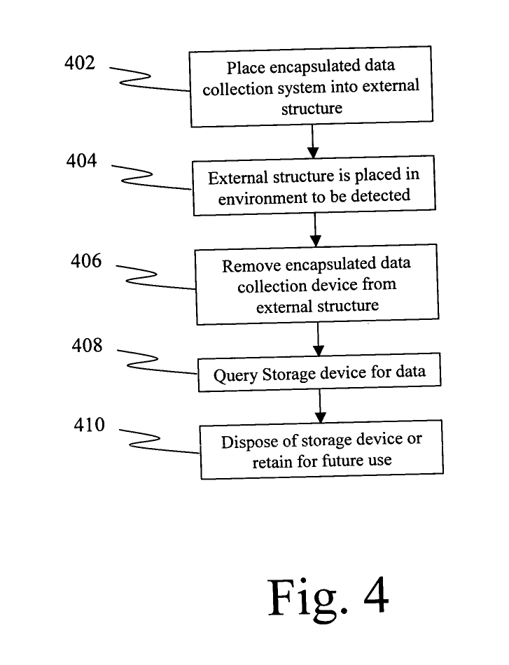

A method of collecting data is shown in FIG. 4. In step 402 (Place encapsulated data collection system into external structure), a naturally encapsulated data storage device 100, containing for example a mechanical disk drive, is placed within an external structure, such as for example an unmanned aircraft.

In step 404 (External structure is placed in environment to be detected), the external structure is subjected to conditions to be detected, in a harsh environment, such as for example by flying an unmanned aircraft over an environment to be detected.

In step 406 (Remove encapsulated data collection device from external structure), the device may be removed from the external structure. Immediately upon its removal, the device may be replaced in the external structure. This step may be skipped in some applications.

In step 408 (Query Storage device for data), the device is electronically queried for its data.

In step 410 (Dispose of storage device or retain for future use), the device may be disposed of, or stored for later use in another external structure.

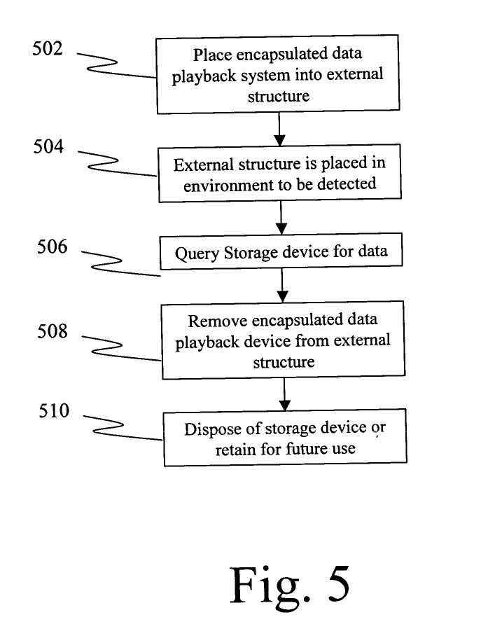

A method of playing back data is shown in FIG. 5. In step 502 (Place encapsulated data collection system into external structure), a naturally encapsulated data storage device 100, containing for example a mechanical disk drive, is placed within an external structure, such as for example an unmanned aircraft. The naturally encapsulated data storage device 100 has been configured to be a read-only device in this exemplary embodiment.

In step 504 (External structure is placed in environment to be detected), the external structure is subjected to conditions to be detected, in a harsh environment, such as for example by flying an unmanned aircraft over an environment to be detected.

In step 506 (Query Storage device for data), the device is electronically queried for its data by the external structure.

In step 508 (Remove encapsulated data collection device from external structure), the device may be removed from the external structure. Immediately upon its removal, the device may be replaced in the external structure. This step may be skipped in some applications.

In step 510 (Dispose of storage device or retain for future use), the naturally encapsulated data storage device 100 may be disposed of, or stored for later use in another external structure.

An exemplary embodiment of the naturally encapsulated data storage device 100 is shown in FIG. 15. In this exemplary embodiment there are two naturally encapsulated data storage device 100 being used. Naturally encapsulated data storage device 100-A is being used in a read-only mode to provide data to the guidance system 1506 of the external structure 1502. The external structure 1502 could be an unmanned aerial vehicle for example. Naturally encapsulated data storage device 100-A is providing this data by means of a wireless communications link 1402.

Also in FIG. 15, naturally encapsulated data storage device 100-B is being used to record data received from a sensor 1504. Naturally encapsulated data storage device 100-B is attached to the external structure 1502 by means of a docking station 1510. The docking station 1510 may provide power, data, and control signals to the encapsulated data storage device 100-B. Additionally, in this exemplary embodiment, the docking station 1510 may be a plug in station, where the encapsulated data storage device 100-B is removable and transportable.

In a preferred embodiment the naturally encapsulated data storage system 100 would be capable of operating within the following environmental parameters:
Altitude 72,000 ft for greater than 96 hours;
Hot Storage 65° C. (85° C.—Design Goal);
Cold Storage −55° C.;
Hot Operation +55° C.;
Cold Operation −20° C.;
Vibration (20-2000) 13.0 Grms overall;
Acceleration 6.0 G;
Submersion Salt water, Hydraulic Fluids, Petrol, and/or n-hexane;
Salt Fog 96 Hours 5% solution; Humidity 100% (condensing); and
Explosion Proof n-hexane to 72,000 ft.

In an exemplary preferred embodiment the naturally encapsulated data storage system 100 may be configured in the following manner:
3.5 inch 400 GB Disk System;
Weight 5 lbs;
Envelope 4×5×7 inches;
Number of Drives 2;
Capacity 400 GB;
Write Data Transfer ˜100 MB/Sec;
Read Data Transfer ˜50 MB/Sec;
Power Consumption 15.5 watts operating; and
Power Consumption 26.75 watts spin-up (power sequencing).

In another exemplary preferred embodiment, the naturally encapsulated data storage system 100 may be configured in the following manner:
3.5 inch 800 GB Disk System;
Weight 10 lbs;
Envelope 4×5×10 inches;
Number of Drives 4;
Capacity 800 GB;
Write Data Transfer ˜180 MB/Sec;
Read Data Transfer ˜150 MB/Sec;
Power Consumption 31 watts operating; and
Power Consumption 42.25 watts spin-up (power sequencing).

In yet another exemplary preferred embodiment, the naturally encapsulated data storage system 100 may be configured in the following manner:
3.5 inch 1.6 TB Disk System;
Weight 20 lbs;
Envelope 4×5×14 inches;
Number of Drives 8;
Capacity 1.6 TB;
Write Data Transfer ˜200 MB/Sec;
Read Data Transfer ˜180 MB/Sec;
Power Consumption 62 watts operating; and
Power Consumption 73.25 watts spin-up (power sequencing);

In still another exemplary preferred embodiment, the naturally encapsulated data storage system 100 may be configured in the following manner:
2.5 inch 240 GB Disk System;
Weight 2.5 lbs;
Envelope 3×5×3 inches;
Number of Drives 4;
Capacity 240 GB;
Write Data Transfer ˜100 MB/Sec;
Read Data Transfer ˜80 MB/Sec;
Power Consumption 10 watts operating; and
Power Consumption 13 watts spin-up (power sequencing).

In still another exemplary preferred embodiment, the naturally encapsulated data storage system 100 may be configured in the following manner:
2.5 inch 480 GB Disk System;
Weight 5 lbs;
Envelope 3×5×6 inches;
Number of Drives 8;
Capacity 480 GB;
Write Data Transfer ˜150 MB/Sec;
Read Data Transfer ˜100 MB/Sec;
Power Consumption 20 watts operating; and
Power Consumption 23 watts spin-up (power sequencing).

Although particular embodiments of the present inventions have been shown and described, it will be understood that it is not intended to limit the present invention to the preferred embodiments, and it will be obvious to those skilled in the art that various changes and modifications may be made without departing from the spirit and scope of the present inventions. Thus, the present invention is intended to cover alternatives, modifications, and equivalents, which may be included within the spirit and scope of the present invention.

1. A naturally encapsulated data storage apparatus for harsh environments comprising:
at least one electromechanical disk drive;
a volume of air captured at room temperature and pressure;
a sealed enclosure encapsulating the electromechanical disk drive and the volume of air at room temperature and pressure, the sealed enclosure consisting essentially of material flowed and hardened in one piece surrounding the electromechanical disk drive;
means for communicating data between the electromechanical disk drive and a controller located outside of the sealed enclosure.

2. The apparatus of claim 1 wherein the material:
is electrically non-conductive;
is thermally insulating due to a low rate of thermal absorption;
has low hygroscopic characteristics, including a very low rate of absorption and very low susceptibility to high moisture and corrosive environments;
exhibits a tensile strength of at least about 10,000 psi;
exhibits a flexural strength of at least about 14,000 psi; and
provides high frequency damping.

3. The apparatus of claim 1 wherein the apparatus is portable and disposable.

4. The apparatus of claim 1 wherein the electromechanical disk drive is non-accessible and non-repairable.

5. The apparatus of claim 1 wherein the electromechanical disk drive is counter-balance mounted to offset gyroscope upsets in zero-gravity environments.

6. The apparatus of claim 1 further comprising a lead based lining for operation in radiation prone environments.

7. The apparatus of claim 1 wherein the apparatus is operable while fully submerged in salt water.

8. The apparatus of claim 1 wherein the apparatus is operable at altitudes above about 70,000 feet above sea level.

9. The apparatus of claim 1 wherein the sealed enclosure is free of mechanical closure devices.

10. The apparatus of claim 1 further comprising a heat conduction plate extending from the electromechanical disk drive to and through the sealed enclosure.

11. The apparatus of claim 1 wherein the sealed enclosure forms a continuous three-dimensional shell.

12. The apparatus of claim 1 further comprising a means for warming the electromechanical disk drive to normal operating temperatures after the apparatus has been exposed to low temperatures for an extended period of time, the means for warming comprising:
means for inhibiting operation of the electromechanical disk drive when the electromechanical disk drive is outside of normal operating temperatures;
a heater for warming the electromechanical disk drive to achieve normal operating temperatures, the heater being mounted inside of the sealed enclosure; and
means for overriding the means for inhibiting operation of the electromechanical disk drive, the means for overriding being capable of selective actuation during critical conditions.

13. The apparatus of claim 1 further comprising a docking station capable of removably receiving the sealed enclosure and adapted to communicate with the electromechanical disk drive inside the sealed enclosure, the docking station comprising:
an isolation tray for reducing the magnitude of vibration and mechanical shock, thereby permitting operation of the apparatus during exposure to vibration and mechanical shock conditions normally harmful to commercial disk drives, and thereby permitting the electromechanical disk drive to survive vibration and mechanical shock conditions at levels normally fatal to disk drives;
an electrical mating connector operatively connected to the isolation tray to adequately provide connection to the sealed enclosure without compromising the integrity of the sealed enclosure;
a heat sink mounted on the isolation tray, the heat sink adapted to assist in dissipation of heat generated within the sealed enclosure and conducted to the exterior of the enclosure by thermal plates.

14. The apparatus of claim 1 wherein the means for communicating data is wireless.

15. The apparatus of claim 1 wherein the material comprises epoxy resin.

16. The apparatus of claim 1 wherein the electromechanical disk drive is a commercial off-the-shelf disk drive normally unreliable in harsh environments.

17. The apparatus of claim 1 further comprising at least a second electromechanical disk drive inside of the sealed enclosure.

18. A method of repeatedly collecting data from a harsh environment, the method comprising:
placing in the harsh environment a naturally encapsulated electromechanical disk drive having sides, a top, and a bottom, the naturally encapsulated electromechanical disk drive having been encapsulated with a volume of air captured in a first non-harsh environment at room temperature and pressure by flowing a fluid material completely around the sides, the top, and the bottom to form a one-piece volumetric shell;
inputting data into the electromechanical disk drive from the harsh environment while the electromechanical disk drive remains encapsulated inside the one-piece volumetric shell;
storing the data on a disk in the naturally encapsulated electromechanical disk drive while the electromechanical disk drive remains encapsulated inside the one-piece volumetric shell;
moving the naturally encapsulated disk drive and the disk from the harsh environment to a second non-harsh environment; and
communicating the data on the disk to the second non-harsh environment.

19. The method of claim 18 further comprising the step of discarding the naturally encapsulated electromechanical disk drive after one use, the one use comprising a single performance of the inputting, storing, moving, and communicating.

20. The method of claim 18 wherein the harsh environment comprises an aircraft flying up to and beyond 70,000 feet.

21. The method of claim 18 wherein the material comprises epoxy resin.

22. The method of claim 18 wherein the inputting and the communicating are accomplished via a standard electrical connector penetrating the one-piece volumetric shell without compromising the integrity of the sealed enclosure.

23. A method of encapsulating an electromechanical disk drive having sides, a top, and a bottom, the method comprising:
Surrounding the sides, top, and bottom, of the electromechanical disk drive with fluid material;
Solidifying the material surrounding the electromechanical disk drive to form a one piece capsule of solidified material, the one piece capsule of solidified material surrounding the sides, the top, and the bottom of the electromechanical disk drive; and
Sealing the electromechanical disk drive in the one piece capsule of solidified material.
